(19) United States
(12) Patent Application Publication
(10) Pub. No.: US 2006/0032682 A1
(43) Pub. Date: Feb. 16, 2006

(54) Skateboard with motorized drive and brake systems

(76) Inventors: Roger Hillman, Westminster, CA (US); Kenneth J. Curran, Thousand Oaks, CA (US); Spencer L. Mackay, Agoura Hills, CA (US); Alan D. Crawford, Burbank, CA (US); Cleve A. Graham, Simi Valley, CA (US); Richard F. Conroy, Simi Valley, CA (US)

Correspondence Address: MYERS DAWES ANDRAS & SHERMAN LLP, 11th Floor, 19900 MacArthur Blvd., Irvine, CA, 92612, US

(21) Appl. No.: 10/888,826

(22) Filed: Jul. 9, 2004

(51) Int. Cl. B60K 1/00

(52) U.S. Cl. 180/65.1

(57) ABSTRACT

A skateboard includes a motorized drive assembly and a motorized brake assembly, both operable with a wireless remote control to be carried by a rider. The drive assembly is free-wheeling permitting normal use of the skateboard in the event of battery depletion. The brake system includes a motor operable through a simple machine structure to move a brake pad against a brake disk mounted against a wheel. A self-adjustment mechanism presets the brake pad a predetermined distance from the disk prior to brake application. Motor enertia is relied on to store potential energy in a wheel axel in accordance with an associated method of operation.

### CROSS REFERENCE TO RELATED APPLICATION

This is a non-provisional application claiming the benefit of co-pending U.S. patent application Ser. No. 10/371,488 filed on Feb. 21, 2003, and entitled “SKATEBOARD WITH REMOTE CONTROLLED MOTIVE POWER,” which is fully incorporated herein by reference.

### REFERENCE TO COMPUTER PROGRAM LISTING APPENDIX

A computer program listing appendix is submitted on a single compact disk, and the material on the disk is hereby fully incorporated by reference. The single compact disk contains the following files:

Name Size Date of Creation

| Name | Size | Date of Creation |
|---|---|---|
| Transmitter | 13.5 KB | May 3, 2004 |
| Receiver/Motor Controller | 31.0 KB | May 3, 2004 |

### BACKGROUND OF THE INVENTION

1. Field of the Invention

This invention relates generally to personal transport vehicles and more specifically to skateboards.

2. Discussion of Related Art

Skateboards were originally intended to transport a rider who provided the only motive power for the skateboard. More recently, skateboards have been provided with battery-powered motors and even engines that provide the motive power for the skateboard. When the motor functions properly, the skateboard performs satisfactorily. However, when the motor ceases to function, it tends to greatly compromise the performance of the skateboard. Free-wheel bearings have been contemplated for skateboards, but not in an optimum configuration.

Motorized drive systems have also been contemplated but have not been provided with control systems that take into account the experience of the rider.

Likewise, brake systems have been contemplated, usually in conjunction with the drive system and mounted on the same truck as the drive system. These brake systems have been highly mechanical, and their controls unfortunately independent of rider experience.

The braking systems of the past have been relatively ineffective and sometimes totally inoperable, for example if the rider is thrown forward as is typical in a braking maneuver.

### SUMMARY OF THE INVENTION

These past deficiencies have been overcome with the present invention, which includes an electronic drive system as well as an electronic brake system. These systems are independent of each other and, in fact, are preferably mounted on separate trucks. Electronic controls associated with the drive and brake systems can be provided with an input dependent on the rider's experience. This input can be used to implement appropriate drive and brake templates that are dependent on the rider's experience. Both of these systems can be operated by a wireless remote control held by the rider.

If either of these electronic systems fail, for example due to battery depletion, the skateboard is provided with free wheeling characteristics so that it can still function in the normal manner, i.e., using the motive power of the rider. A microprocessor-controlled transmitter in the remote control communicates with a microprocessor-controlled receiver in the skateboard. Both drive signals and brake signals are communicated through this wireless interface. In the event that a brake signal is generated, the control can be programmed to override any drive signal.

The brake system associated with the present invention is highly effective as it incorporates a disk well known for its improved brake characteristics. In this case, each of the wheels of the trucks supporting the brake system is provided with a disk that can be mounted against the inner surface of an associated wheel. A single brake pad is operable against an opposing surface of the disk to create the braking action. A mechanical advantage is derived through a lead screw and a pair of levers included in the preferred embodiment.

The brake system also includes an automatic adjustment mechanism that can be activated during a start-up procedure and/or each time the braking action is discontinued. In accordance with this procedure for automatic brake adjustment, the brake pads are pressed against their associated disks and then withdrawn a predetermined distance from the disk. In this manner, the pad is always spaced from the disk by the predetermined distance each time the brake is applied.

The skateboard is provided with a speed monitor that can be used for various purposes. In one aspect of the invention, the monitor limits the maximum speed of the board and, accordingly, the maximum current drawn from the battery pack.

In another aspect of the invention, a motorized skateboard includes a riding platform having a front end and a back end. A rear truck supports a first pair of wheels at the back end of the platform while a front truck supports a second pair of wheels at the front end of the platform. A drive assembly carried by the rear truck provides motive power to the first pair of wheels. A brake assembly carried by the front truck is operable only at the front end of the riding platform to provide braking power to the second pair of wheels. The brake assembly includes a self-adjustable disk brake.

In another aspect, the invention includes a brake truck adapted for use with a skateboard and including an axle housing and an axle disposed in the housing. A pair of wheels mounted on the axle is rotatable relative to the housing, and a brake disk is rotatable with each one of wheels. A brake pad movable relative to the brake disk functionally engages the disk to inhibit rotation of the disk and the wheel. An actuation assembly is operable to carry the brake pad into frictional engagement with the disk. This assembly includes a lead screw and lever operable to provide a mechanical advantage to the brake pad.

In another aspect of the invention, a motorized skateboard includes a drive assembly with a motor that is adapted to provide motive power to the skateboard. A brake assembly includes a brake motor that is adapted to provide braking power to the skateboard. A remote control is coupled in wireless communication with the drive assembly and the brake assembly.

In a further aspect, a brake system is adapted for use in braking a wheel of the vehicle. This system includes a brake rotor rotatable with the wheel and a brake pad movable relative to the rotor into frictional contact with the rotor. A brake motor is adapted to move the pad relative to the rotor. A controller coupled to the motor is operable to move the pad to a first position wherein the pad is disposed a fixed distance from the motor and a second position wherein the pad is disposed a variable distance from the motor. In the first position, the pad frictionally engages the rotor. In the second position, the pad is disposed a predetermined distance from the rotor.

These and other features and advantages will become more apparent with a description of preferred embodiments of the invention and reference to the associated drawings.

### DESCRIPTION OF THE DRAWINGS

FIG. 1 is a side elevation view illustrating a skateboard of the present invention operable by a wireless remote control;

FIG. 2 is a perspective exploded view of the skateboard including a drive assembly and a brake assembly;

FIG. 3 is a perspective exploded view of the drive assembly illustrated in FIG. 2;

FIG. 4 is a perspective exploded view of the brake assembly illustrated in FIG. 2;

FIG. 5 is an assembled view of the brake assembly including a mechanism for self-adjustment of a brake pad;

FIG. 6 is a perspective exploded view of the self-adjustment mechanism illustrated in FIG. 5;

FIG. 7 is a cross section view of the self-adjustment mechanism taken along lines 7-7 of FIG. 5;

FIG. 8 is a cross section view of the self-adjustment mechanism taken along lines 8-8 of FIG. 7;

FIG. 9 is a perspective exploded view of a remote control associated with the present invention;

FIG. 10 is a rear elevation view of the remote control illustrated in FIG. 9;

FIG. 11 is a cross section view taken along lines 11-11 of FIG. 10;

FIG. 12 is a schematic view of a transmitter associated with the remote control of FIG. 9; and

FIG. 13 is a schematic view of a receiver and motor controller associated with the skateboard of FIG. 2.

### DESCRIPTION OF PREFERRED EMBODIMENTS AND BEST MODE OF THE INVENTION

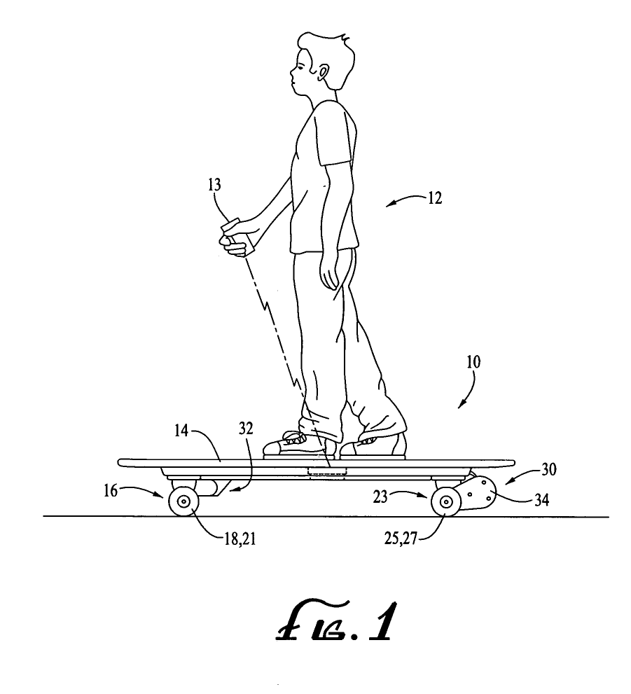

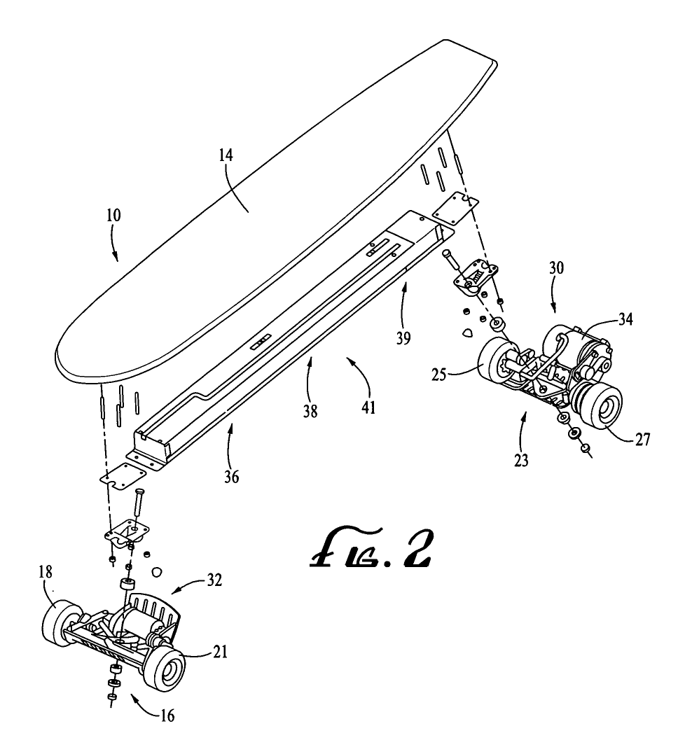

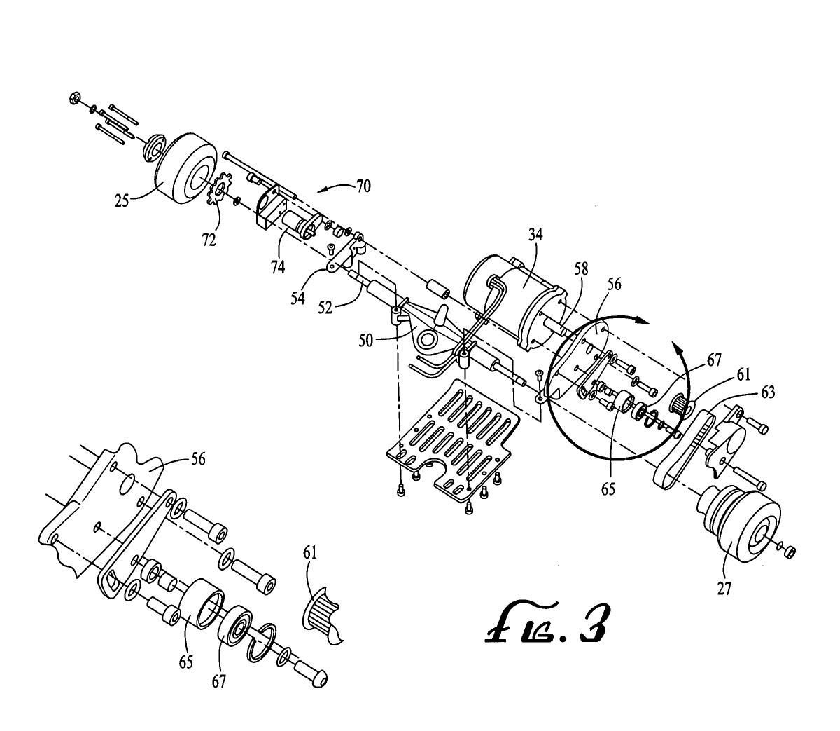

A skateboard is illustrated in FIG. 1 and designated generally by the reference numeral 10. As illustrated in this view, the skateboard is adapted to be ridden by a rider 12 and operated by a wireless remote control 13.

In the past, skateboards have been passive in nature, meaning that they have had no motive power of their own, but have relied entirely on the rider 12 for movement. Typically the rider 12 would pump the skateboard with one foot on the skateboard and the other foot on the ground. When a desired level of speed was achieved, the rider 12 would place both feet on the skateboard and coast until additional speed was desired.

A typical skateboard includes a platform 14 supported by a front truck 16 having a pair of wheels 18 and 21, and a rear truck 23 having a pair of wheels 25 and 27. In the past, all four wheels 18, 21, 25 and 27 have been freewheeling in both a forward direction and a rearward direction.

In the embodiment illustrated in FIG. 1, the skateboard 10 retains the passive mode of operation wherein all four of the wheels 18, 21, 25 and 27 are freewheeling. But this skateboard 10 also has an active mode wherein its speed is controlled by a drive assembly 30 and a braking assembly 32. The drive assembly 30 includes motive means such as an engine or a motor 34. Electrical power in this embodiment is provided to the motor 34 by a pair of battery banks 36 and 38 operating through a printed circuit board 39, all of which are housed in a battery compartment 41.

In certain preferred embodiments, the drive assembly 30 is carried by one of the trucks 16 and 23, while the braking assembly 32 is carried by the other of the trucks 23 and 16. In the illustrated embodiment, the drive assembly 30 is included in the rear truck 23 while the braking assembly 32 is included in the front truck 16. This arrangement is of particular advantage as it separates the complexities of the drive assembly 30 and braking assembly 32 so they can operate generally independently on the skateboard 10. Of course, this independent operation can also be achieved by placing the drive assembly on the front truck 16 and the braking assembly 32 on the rear truck 23.

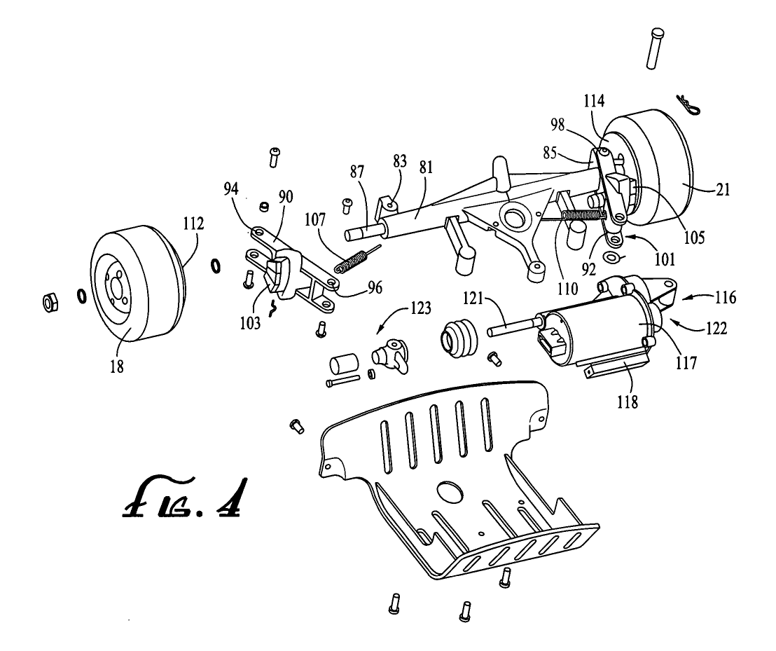

The rear truck 23 is illustrated in the exploded view of FIG. 3. In this view, it can be seen that the rear truck 23 of this embodiment includes an axle housing 50 with an axle 52 disposed within the housing 50. A pair of brackets 54 and 56 support the motor 34 on the axle housing 50. A drive shaft 58 associated with the motor 34 is coupled through a drive sprocket 61 to drive a belt 63 and rotate the wheel 27. A tension pulley 65 can be mounted on a bearing 67 to maintain an appropriate tension on the belt 63.

On the opposite side of the axle housing 50, a tachometer assembly 70 can be provided between the bracket 54 and the wheel 25. In this embodiment, the tachometer assembly 70 includes a rotor 72 that is mounted in a fixed relationship with the wheel 25. The perimeter of the rotor 72 is provided with equally spaced notches that provide a broken field within the line of sight of a sensor 74. As the wheel 25 rotates, the rotor 72 also rotates and the number of notches passing before the sensor 74 is calculated per unit of time. In this manner, the angular velocity of the rotor 72 and wheel 25 can be determined along with the linear velocity of the skateboard 10.

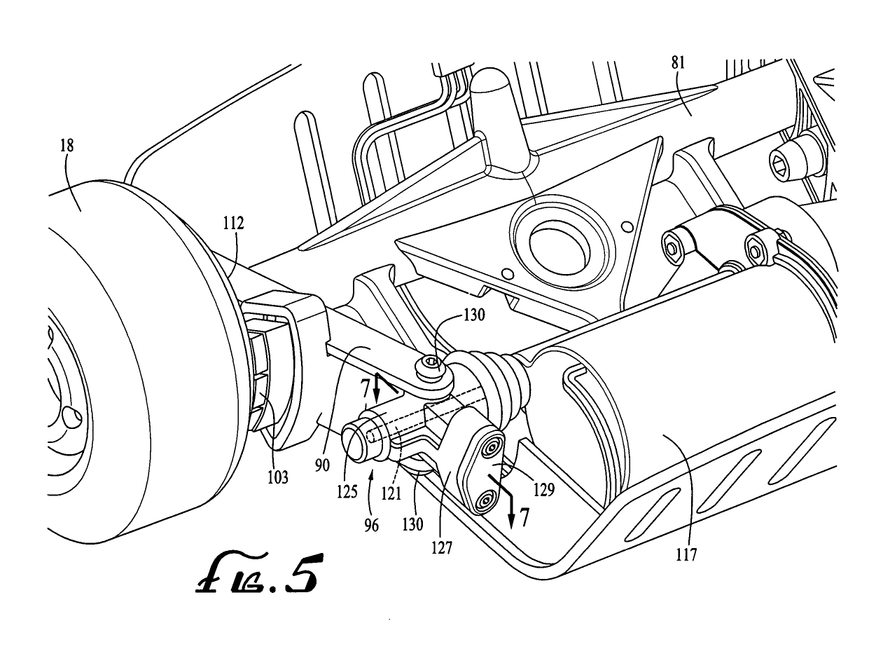

A preferred embodiment of the front truck 16 is illustrated in the exploded view of FIG. 4. In this embodiment, an axle housing 81 is provided with a pair of mounting lugs 83 and 85. An axle 87 is fixed within the housing 81 with opposing ends of the axle 87 rotatably supporting the wheels 18 and 21. Of course, in an alternate embodiment, the wheels 18 and 21 can be fixed to the axle 87, which is then rotatably supported within the housing 81.

A pair of braking arms is provided in the form of lever arms 90 and 92. The lever arm 90 is provided with opposing ends 94 and 96, while the lever arm 92 is provided with opposing ends 98 and 101. In this embodiment, a brake pad 103 is mounted to the lever arm 90 between the ends 94 and 96. Similarly, a brake pad 105 is mounted to the lever arm 85 between the ends 98 and 101. In each case, the brake pads 103 and 105 face outwardly of the axle housing 81.

During assembly of the rear truck 23, the end 94 of the lever arm 90 is rotatably attached to the mounting lug 83 of the axle housing 81. Similarly, the end 98 of the lever arm 92 is attached to the lug 85. A pair of tension springs 107 and 110 can also be mounted between the axle housing 81 and the lever arms 90 and 92, respectively. The wheels 18 and 21 can then be mounted to opposing ends of the axle 87 together with their brake disks 112 and 114, respectively, which are discussed in greater detail below.

In the illustrated embodiment, the motor assembly 116 includes a brake motor 117, which is mounted between the ends 96 and 101 of the lever arms 90 and 92, respectively. In this location, the motor 117 floats relatively free of the axle housing 81 in order to apply equal forces against the lever arms 90 and 92. The floating of the motor 116 is of particular interest in a direction parallel to the axle 87. Additional support and guidance for the motor 116 can be provided in the form of a guide 118, which is oriented to on the axle housing 81 while accommodating the parallel float of the motor 116.

A lead screw 121 can be provided for operation through a gear assembly 122 by the motor 117. It is this lead screw 121 that is connected through a brake self-adjustment mechanism 123 to the end 96 of the lever arm 90. The opposite side of the motor assembly 116 is connected to the end 101 of the lever arm 92.

In operation, the motor 117 is can be controlled to move the lead screw 121 out of the motor assembly 116, to the left in FIG. 4. This operates to force the ends 96 and 101 of the lever arms 90 and 92, respectively, in opposite directions, away from each other. This, in turn, causes the pads 103 and 105 to be forced against the disks 112 and 114 respectively to frictionally inhibit rotation of the associated wheels 18 and 21. Between the motor 117 and the pads 103, 105, the lead screw 121 as well as the lever arms 90 and 92 provides a mechanical advantage to the power of the motor 117. Other simple machines such as an incline plane could be employed for this purpose.

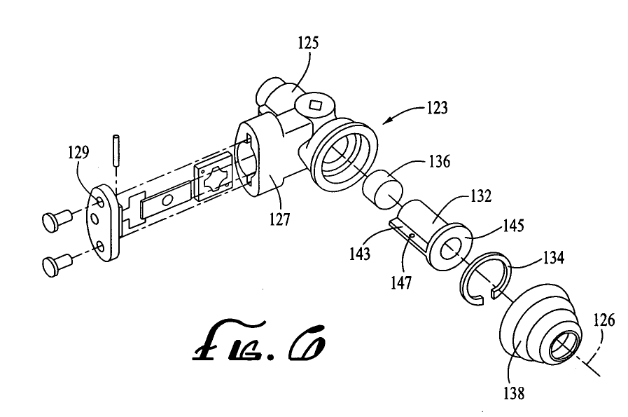

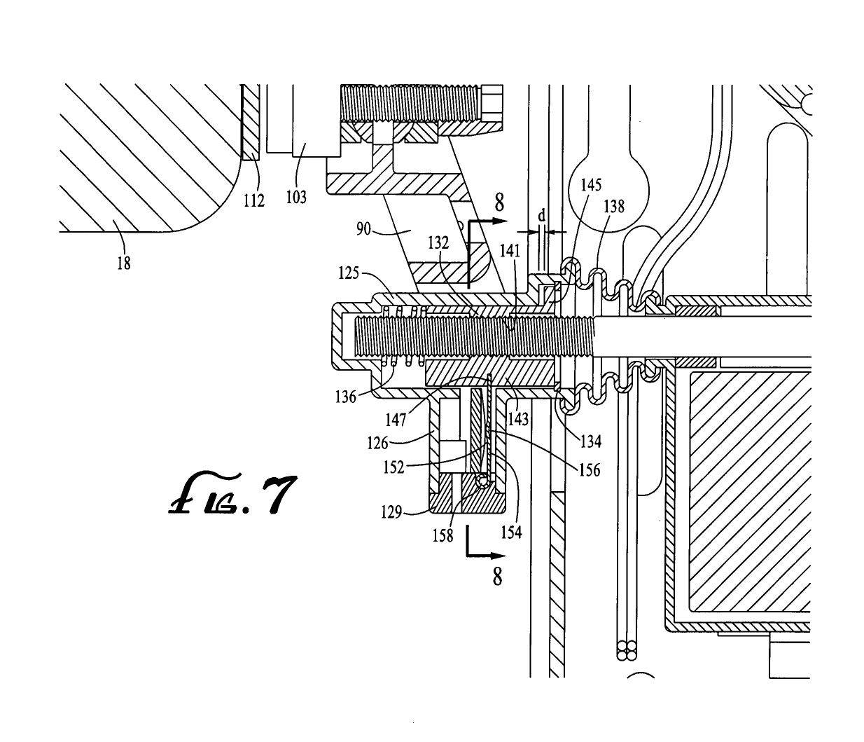

Of particular interest to this embodiment is the brake self-adjustment mechanism 123, which is shown in greater detail FIGS. 5-8. This brake self-adjustment mechanism 123 includes a bell housing 125 centered on an axis 126, and a lateral housing 127 having a cover 129. The bell housing 125 is positioned to receive the lead screw 121 of the motor 117. The lateral housing 127 communicates in a generally perpendicular relationship with the bell housing 125 and the associated lead screw 121. Either the bell housing 125 or the lateral housing 127 can be pivotally attached to the end 96 of the brake lever 90, for example, by a pair of screws 130.

As the braking action is initiated, the self-adjustment mechanism 123 moves outwardly, to the left in FIG. 5, causing the lever 90 to force the pad 103 against the disk 112 of the wheel 18. Conversely, as the braking action is reduced or discontinued, the self-adjustment mechanism 123 moves inwardly, to the right in FIG. 5, causing the lever 90 to withdraw the pad 103 from the disk 112. In the manner discussed in greater detail below, it is the rotation of the lead screw 121, which moves the self-adjustment mechanism 123 outwardly and inwardly to operate the brakes of the skateboard 10.

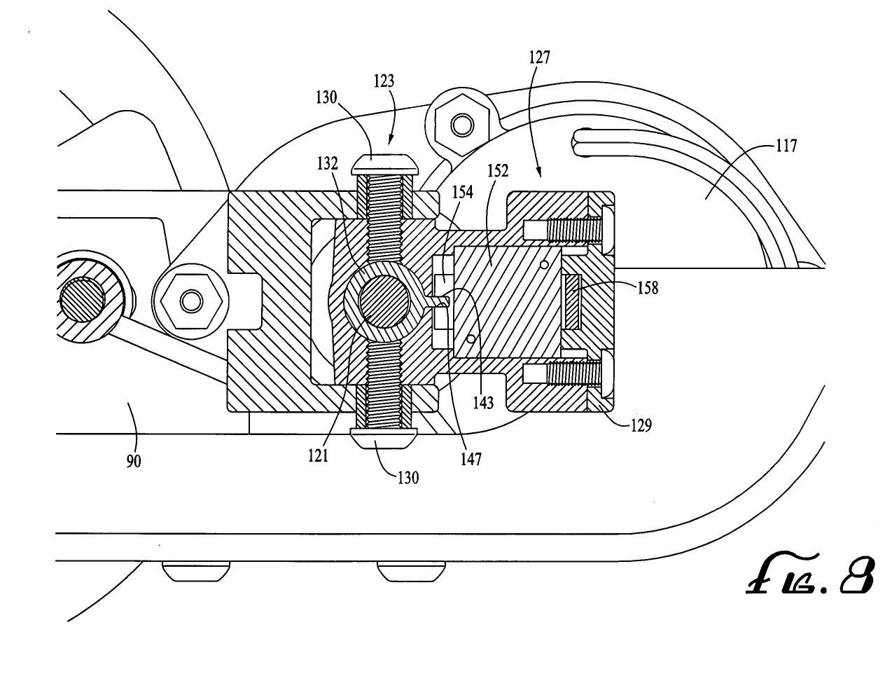

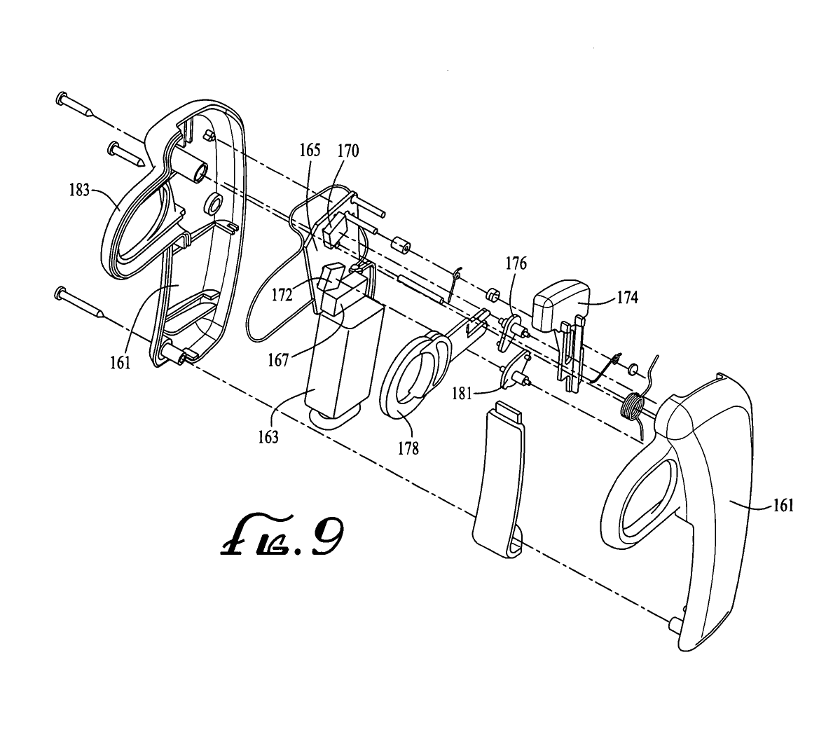

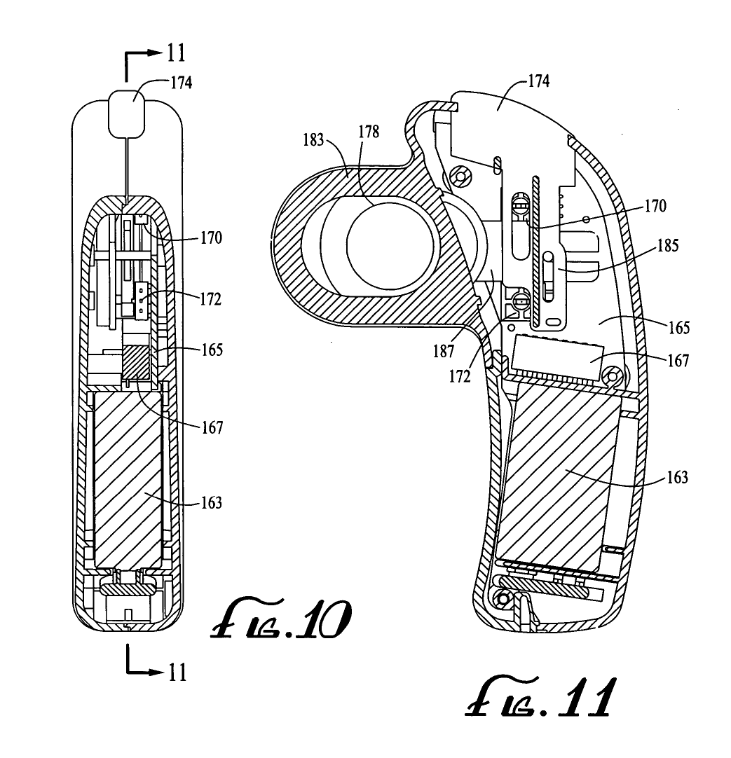

Operation of the self-adjustment mechanism 123 can be best understood with reference to the assembly view of FIG. 6 and the cross sectional views of FIGS. 7 and 8. As illustrated in FIG. 6, the brake self-adjustment mechanism 123 includes an internally threaded nut 132, which is held in the bell housing 125 against the bias of a spring 136 by a snap ring 134. A self-adjusting bellows 138 is provided to extend between the bell housing 125 and the brake motor 117. As shown in FIG. 7, the lead screw 121 associated with the motor 117 extends through the bellows 138, and within the bell housing 125 through the clip 134, the nut 132, and the spring 136. Importantly, the nut 132 is provided with internal threads 141 that engage the external threads of the lead screw 121. It can now be appreciated that as the lead screw 121 turns in one direction, the nut 132 translates outwardly to the left in FIG. 7 driving the pad 103 against the disk 112. As the lead screw 121 turns in the opposite direction, the nut 132 translates inwardly, to the right in FIG. 7, drawing the pad 103 away from the disk 112.

In this particular embodiment, the nut 132 is also provided with a key 143 that extends parallel to the axis 126 and an annular flange 145 which is disposed in a plane perpendicular to the axis 126. A notch 147 is provided in key 143.

A dome switch 152 and a lever 154 are disposed within the lateral housing 127, the lever having a lateral projection 156. The dome switch 152 is fixed within the housing 127 while the lever 154 is pivotal at one end on a pin 158, which is mounted in the cover 129. The opposite end of the lever 154 is seated within the notch 147 of the key 143 associated with the nut 132. As shown in FIG. 7, the projection 156 of the lever 154 is positioned in juxtaposition to the dome of the switch 152. It can now be seen that as the lead screw 121 turns and the nut 132 translates outwardly relative to the bell housing 125, the key 143 will cause the projection 156 of the lever 154 to pivot into the dome switch 152. This will actuate the dome switch 152 thereby providing an electrical signal to the motor 117, as discussed in greater detail below.

At this point, it is of particular interest to note that the nut 132 is free to float axially within the bell housing 125, but only for a short distance designated by the reference letter “d” in FIG. 7. As the lead screw 121 turns, the nut 132 will move along the lead screw 121, outwardly. Although the nut 132 moves relative to the lead screw 121, initially it will not move relative to the housing 125 due to the force of the spring 136 between the housing and the nut. In other words, the distance “d” separating the flange 145 from the housing 125 is initially maintained by the spring 136. During this phase of operation, both the housing 125 and the nut 132 translate along the screw 121 but do not move relative to each other.

However, as the housing 125 moves outwardly, the pad 103 eventually comes into contact with the disk 112. This creates resistance to any further outward movement of the housing 125. But the nut 132 continues to translate outwardly. Under these circumstances, the spring 136 begins to compress thereby closing the distance “d” and, for the first time the nut 132 and the key 143 moves relative to the housing 125. This causes the lever 154 to pivot against the stationary dome switch 152. As a result, the switch is closed thereby providing an electrical indication of contact between rotor 103 and the disk 112.

In this embodiment, this electrical indication is used to remove power from the motor 117. Although the motor 117 electronically has been shut off, its mechanical inertia will continue to move the pad 103 against the disk 112. Importantly, this additional force will tend to bend the axel 87 thereby loading the system with potential energy. The bent axel 87 effectively becomes a major spring in the brake system.

As the process of self brake adjustment continues, the lead screw 121 is now turned in the opposite direction thereby causing the nut 132 to translate inwardly, to the right in FIG. 7. Notwithstanding the compression of the spring 136, which would tend to separate the nut 132 from the housing 125, the potential energy associated with the bent axle 87 causes the housing 125 to move inwardly with the nut 132. The common movement continues until the spring force of the bent axle 87 is relieved at which point the spring 136 will cause separation of the nut 132 and housing 125. At this point in time, the separation distance “d” is developed and, importantly, the nut 132 moves relative to the housing 125. This relative movement also moves the lever 154 away from the dome switch 152 thereby creating an open circuit to de-energize the motor 117.

At this point in time, the brake pad 103 may still be next to the disk 112. This is the case even though the major spring force associated with the bent axle 87 and the spring 136 has been fully relieved. However, due to mechanical inertia, the motor will continue to turn and the lead screw 121 will continue to translate inwardly. It is during this time that the brake pad 103 is drawn away from the disk 112 a predetermined distance. As described in greater detail below, this automatic brake adjustment can be performed during an initial startup sequence and/or each time the brake is applied and then relieved. As a result, the pad 103 and disk 112 are always maintained by the self-adjustment that dictates their predetermined spatial relationship.

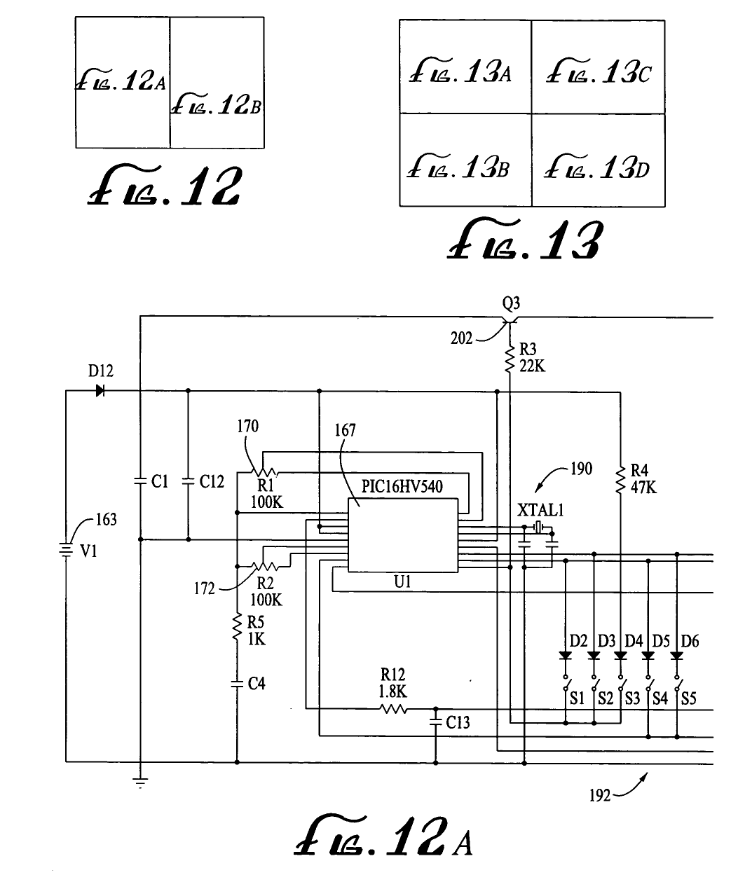

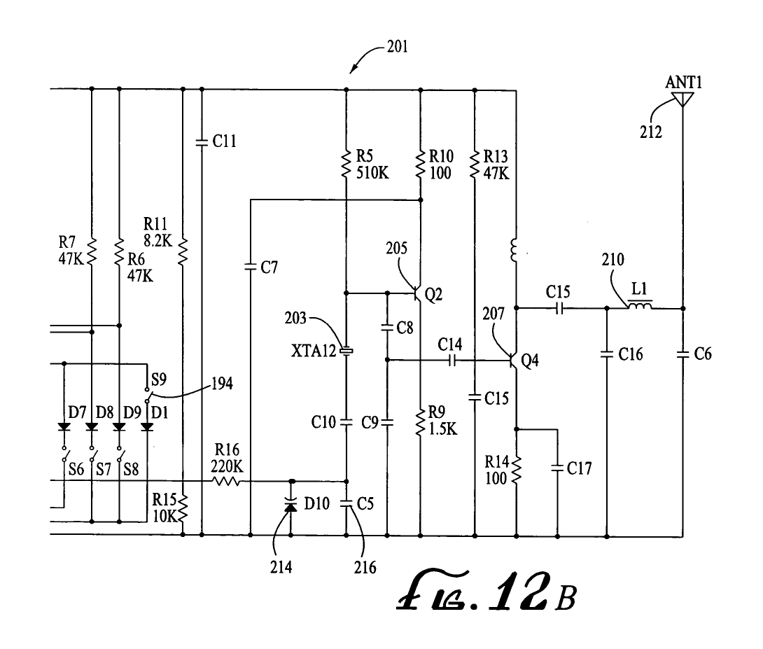

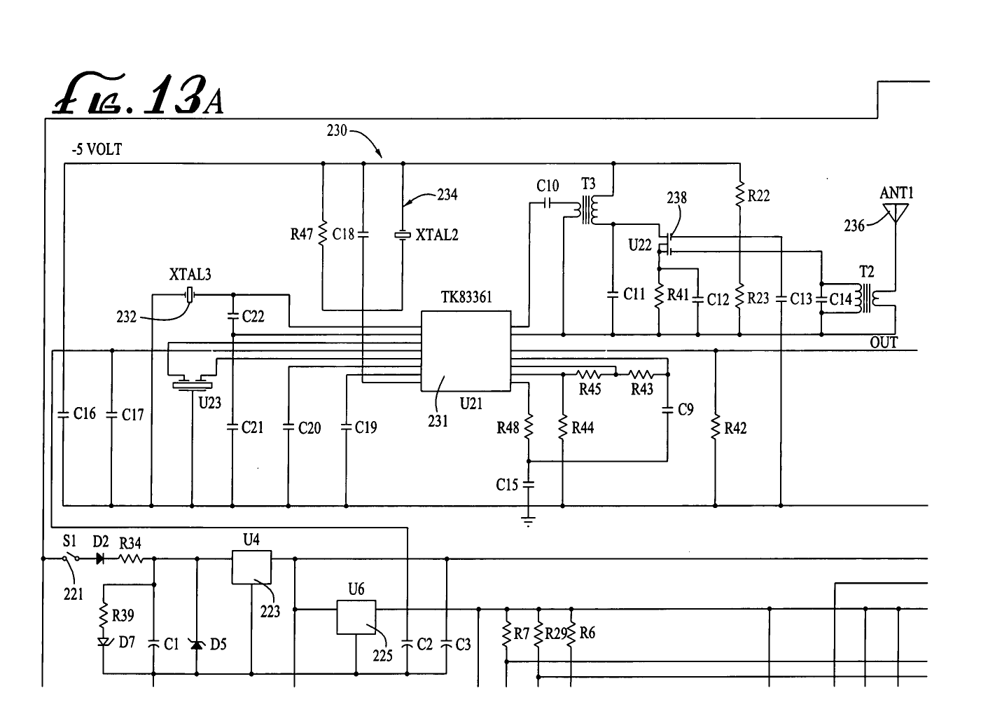

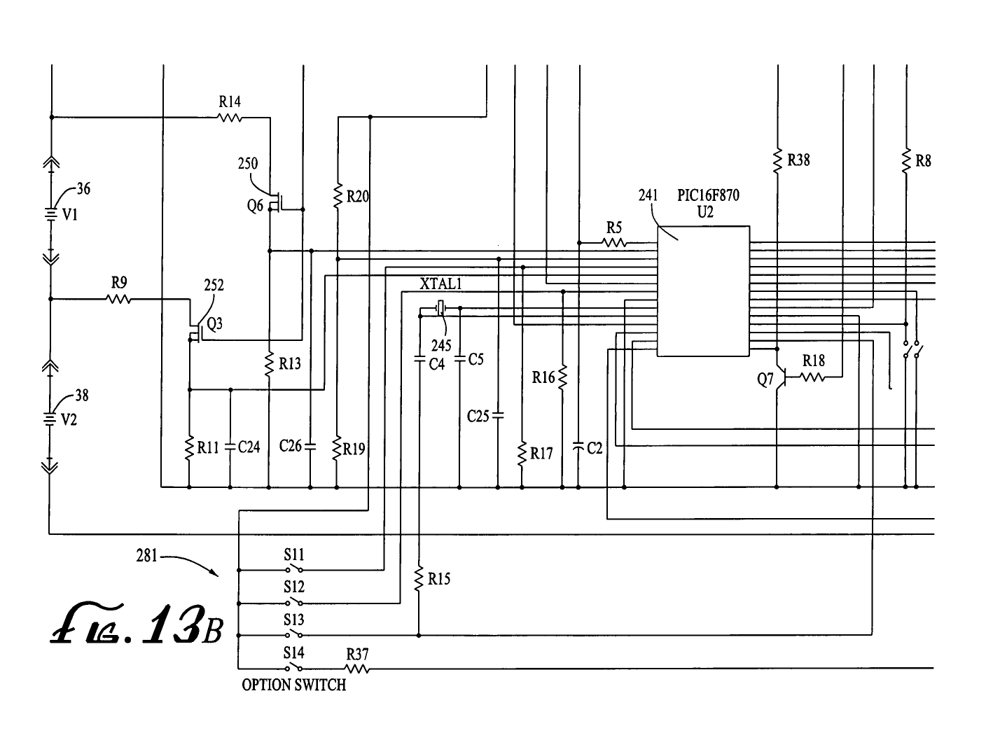

A preferred embodiment of the wireless remote control 13 is illustrated in the assembly view of FIG. 9 and the cross sectional views of FIGS. 10 and 11. The control 13 includes a clamshell housing 161 formed with a left side and a right side. Within the housing 161, a battery 163 powers a printed circuit board 165 that includes a microprocessor 167 as well as a brake potentiometer 170 and a drive potentiometer 172. A brake button 174 extends through the housing for operation by the user's thumb. As the rider 12 depresses the brake button 174, the brake potentiometer 170 is adjusted through a brake gear drive 176. In a similar manner, a drive trigger 178 is operable by a finger of the rider 12 to vary the drive potentiometer 172 through a drive gear 181. Portions of the housing 161 can be used to form a protective housing 183 for the drive trigger 178.

As best illustrated in the cross section views of FIGS. 10 and 11, the brake button 174 can be provided with an extension 185 that converts the transational movement of the button 174 into rotational adjustment of the brake potentiometer 170. In like manner, the drive trigger 178 can be provided with an extension 187 that converts the transational movement of the trigger 178 into rotational adjustment of the drive potentiometer 172. In the manner illustrated and described in greater detail below, the adjustment of the potentiometers 170 and 172 provides for variations in a wireless signal transmitted from the printed circuit board 165 in the remote control 13 to the printed circuit board 39 in the skateboard 10. It is this signal that is processed to operate the associated motors and mechanical components as previously discussed.

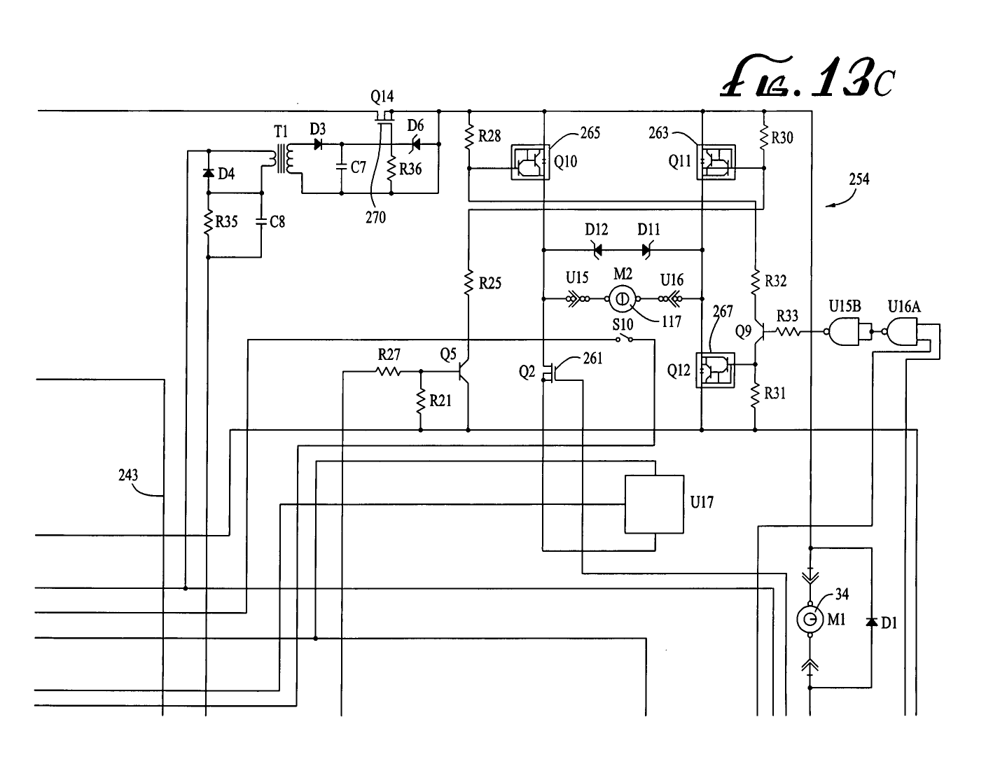

The circuitry associated with the printed circuit board 165 is illustrated in FIG. 12 where the battery 163 and microprocessor 167 are shown together with the brake potentiometer 170 and the drive potentiometer 172. A microprocessor crystal 190 is also shown in FIG. 12. The microprocessor 167 in this embodiment is a PIC16HV540, which will run without regulation providing a digital input to an A to D converter.

A dipswitch 192 is provided to facilitate the input of an individual code for each remote control 13 and platform 14 combination. With eight switches available in the dipswitch 192, a total of 256 codes are available in the preferred embodiment.

An on/off switch 194 can be used to provide an open circuit when the potentiometers 170 and 172 are closed. This switch 194 ensures that the battery 163 is not drained when the remote control 13 is not in use.

To the right in the schematic of FIG. 12, an RF section 201 provides a narrow band frequency modulated transmitter for this embodiment. The RF section 201 includes a power switch 303 and crystal 203 that generally dictate the frequency of the transmitter. The RF section 201 also includes an oscillator 205 and an amplifier 207 together with an output filter 210 and an antenna 212.

Of particular interest to the RF section 201 is a variactor 214 that operates to change the characteristics of a capacitor 216 thereby adjusting the voltage from the microprocessor 167 as it is applied to the oscillator 205. With slight changes in this voltage, the crystal 203 is pulled off its frequency slightly in accordance with operation of the potentiometers 170 and 172.

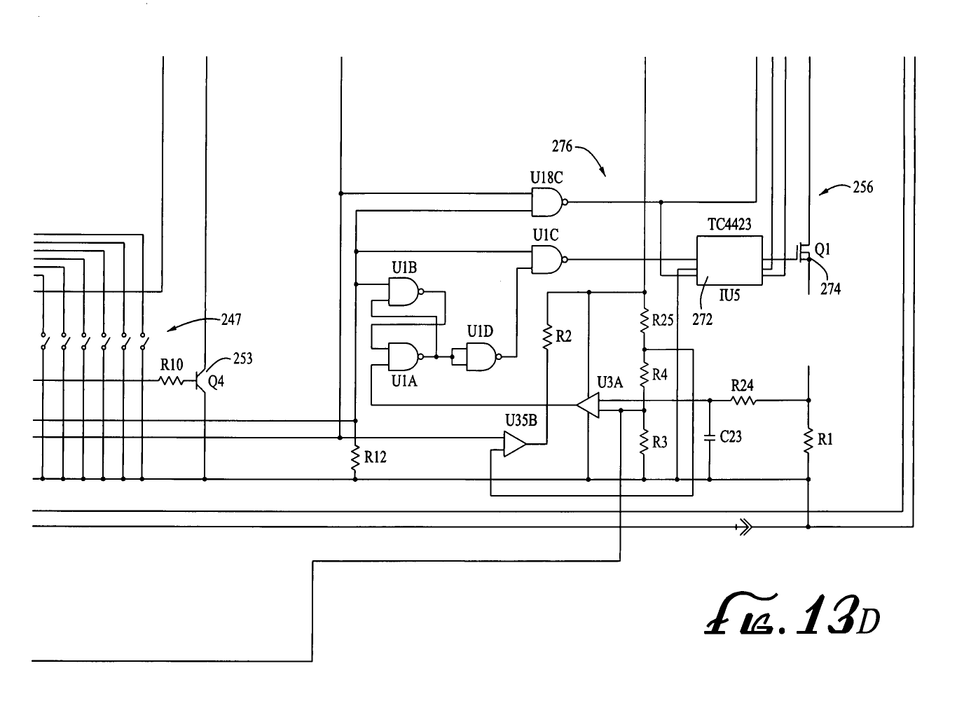

The printed circuit board 39 associated with the platform 14 can be housed in the compartment 41 together with the battery banks 36 and 38. The circuitry associated with a preferred embodiment of this printed circuit board 39 is illustrated in the schematic of FIG. 13. This circuitry is powered by the battery banks 36 and 38, which are controlled by an on/off switch 221, a 12-volt regulator 223, and a 5-volt regulator 225.

A receiver section 230 is shown in the upper left hand corner of FIG. 13. This receiver 230 includes a bipolar microprocessor 231, specifically TK83361, which is coupled to a local oscillator 232 and discriminator 234. The oscillator 232 functions as a mixer with a crystal frequency offset by 455 KHz in the preferred embodiment. This differential also dictates the frequency of the discriminator 230.

The digital signal transmitted from the RF Section 201 (FIG. 12) is received through an antenna 236 and input to the microprocessor 230. Appropriate amplification of the signal is provided by a dual-gate MOSFET 238. An output from the microprocessor 231 provides an input to a second microprocessor 241 on line 243.

In a preferred embodiment, the microprocessor 241 is a PIC16F870, which functions with a crystal 245 at 8.00 MHz. Other inputs to the microprocessor 241 include a dipswitch 247, which is provided with the same code as the switch 192 in the transmitter of FIG. 12. The microprocessor 241 is also controlled by a pair of FETs 250 and 252, which disconnect the battery banks 36 and 38 when the receiver 230 is off, thereby inhibiting the monitoring function of the microprocessor 241. A transistor 253 toggles during operation of the microprocessor 241.

A brake circuit 254 and a drive circuit 256 are shown generally to the right in FIG. 13. The brake circuit 254 includes the brake motor 117, which is controlled by an H-drive or bridge 258. This bridge 258 includes transistors 261 and 263 that turn the brake motor on, and transistors 265 and 267 that turn the brake motor off. A further transistor 270 is provided to remain in an on state as long as the transistor 253 associated with the microprocessor 241 is toggling. This ensures that both the brake circuit 254 as well as the drive circuit 256 effectively shut down when the microprocessor 241 is inoperative. The dome switch associated with the brake self-adjustment mechanism 123 of FIG. 6 is designated by its reference numeral 152 in this brake circuit 254.

In the drive circuit 256, the current input to the drive motor 34 is controlled by a driver 272 and associated transistor 274. Realizing that, if this transistor 274 were to fail, it would do so in an on state, one can appreciate that this failure mode would present an inordinately high current to the motor 34. In order to avoid this undesirable effect in the failure mode, a current limiting circuit 276 is provided in the illustrated embodiment.

Of particular interest to this circuitry is a dipswitch 281, which can be set by the rider 12 in accordance with his individual experience. Accordingly, the switch 281 can be set to reflect the experience of a beginner, intermediate or advanced rider 12. Each experience level or setting provides a different template or curve for each of the brake circuit 254 and drive circuit 256. For example, when the switch 281 is set to a beginner level, the curve is flatter resulting in more gradual acceleration and braking. After the rider 12 has gained experience, the switch 281 can be set to the intermediate or advanced settings. In the advanced setting, for example, the acceleration and braking curves ramp at an increased rate to give the skateboard 10 higher performance characteristics.

A computer program listing appendix is provided to show how the various microprocessors in FIGS. 12 and 13 can be programmed to facilitate the operation and control of the skateboard 10. A first listing is provided for the microprocessor 167 associated with the transmitter in the remote control 13. A second listing is provided for the microprocessors 230 and 241 in the receiver circuitry of FIG. 13.

Although the present invention has been disclosed with reference to specific embodiments, it will be apparent that the various modifications and additions will now be obvious to those of ordinary skill in the art. Accordingly, one is cautioned not to determine the extent of this invention only with reference to the preferred embodiments, but rather encouraged to determine the scope of the invention only with reference to the following claims.

1. A motorized skateboard, including:
a riding platform having a front end and a back end;
a drive truck having a first pair of wheels and being disposed at one of the front end and the back end of the platform;
a brake truck having a second pair of wheels and being disposed at the other of the front end and the back end of the platform;
a drive assembly carried by the drive truck and providing motive power to the first pair of wheels;
a brake assembly carried by the brake truck and providing braking power to the second pair of wheels;
a brake included in the brake assembly; and
an adjustment mechanism included in the brake assembly and providing for self-adjustment of the brake.

2. The motorized skateboard recited in claim 1, wherein the drive truck is disposed at the back end of the platform.

3. The motorized skateboard recited in claim 1, wherein the drive truck is disposed at the front end of the platform.

4. The motorized skateboard recited in claim 1, wherein the brake is a disk brake.

5. The motorized skateboard recited in claim 1, wherein the drive assembly includes a drive motor and the brake assembly includes a brake motor operable independently of the drive motor.

6. A brake truck adapted for use with a skateboard, including:
an axle housing;
an axle disposed in the axel housing;
a pair of wheels mounted on the axle in a rotatable relationship with the housing;
a brake rotor rotatable with an associated one of the wheels;
a brake pad movable relative to the brake rotor to functionally engage the rotor and inhibit rotation of the rotor and the associated wheel;
an actuation assembly operable to carry the brake pad into frictional engagement with the rotor;
a motor included in the actuation assembly; and
at least one simple machine included in the actuation assembly to provide a mechanical advantage between the motor and the brake pad.

7. The motorized skateboard recited in claim 6, wherein the at least one simple machine includes a lead screw.

8. The motorized skateboard recited in claim 6, wherein the at least one simple machine includes a lever.

9. The motorized skateboard recited in claim 6, further comprising:
a brake self-adjustment mechanism included in the actuation assembly.

10. The motorized skateboard recited in claim 6, wherein the brake rotor is a brake disk.

11. The motorized skateboard recited in claim 6, wherein the actuation assembly is operable to carry the brake pad along a path generally parallel to the axel.

12. The motorized skateboard recited in claim 6, wherein the rotor is a first rotor, the pad is a first pad, and the brake truck further comprises:
a second brake rotor rotatable with the other wheel; and
a second brake pad movable relative to the second brake disk to functionally engage the second brake disk and inhibit rotation of the second brake disk and the other wheel.

13. A motorized skateboard, including:
a drive assembly;
a drive motor included in the drive assembly and adapted to provide motive power to the skateboard;
a brake assembly;
a brake motor included in the brake assembly and adapted to provide braking power to the skateboard; and
a remote control coupled in electrical communication to the drive assembly and the brake assembly.

14. The motorized skateboard recited in claim 13, wherein the brake assembly includes a self-adjustment mechanism.

15. The motorized skateboard recited in claim 14, wherein the drive assembly includes a free-wheel mechanism.

16. The motorized skateboard recited in claim 13, wherein the remote control is coupled in wireless communication with the drive assembly and the brake assembly

17. A brake system adapted for use in braking a wheel of a vehicle, including:
a brake rotor rotatable with the wheel;
a brake pad movable relative to the rotor in frictional engagement with the rotor;
a brake motor adapted to move the pad relative to the rotor;
a controller coupled to the motor and operable to move the pad between a first position and a second position;
the pad in the first position being disposed a fixed distance from the motor and a variable distance from the motor; and
the pad in the second position being disposed a predetermined distance from the rotor.

18. The brake system recited in claim 17, wherein the pad in the first position frictionally engages the rotor.

19. The brake system recited in claim 18, wherein the variable distance between the pad in the first position and the motor is dependent on the wear of the brake pad.

20. The brake system recited in claim 17, wherein the brake rotor is a brake disk.

21. A method for self-adjusting a brake system, comprising the steps of:
providing an axel supporting a rotatable wheel, a brake rotor having a fixed relationship with the wheel, a brake pad movable to frictionally engage the brake rotor, and a brake motor;
energizing the motor to move the brake pad from a first position spaced a predetermined distance from the rotor, to a second position in contact with the rotor;
denergizing the motor:
loading a spring with potential energy from the enertia of the brake motor, following the denergizing step;
energizing the motor to drain the potential energy from the spring;
denergizing the motor with the brake pad in the second position; and
moving the brake pad from the second position to the first position with the enertia of the motor.

22. The method recited in claim 21, wherein the spring is the axel.
